(19) United States
(12) Patent Application Publication
(10) Pub. No.: US 2023/0320272 A1
(43) Pub. Date: Oct. 12, 2023

(54) Combine Harvester Control System

(71) Applicant: AGCO International GmbH, Neuhausen (CH)

(72) Inventor: Dan Hermann, Randers (DK)

(21) Appl. No.: 18/044,186

(22) PCT Filed: Sep. 27, 2021
(86) PCT No.: PCT/IB2021/058773

§ 371 Date: Mar. 6, 2023

(30) Foreign Application Priority Data
Oct. 31, 2020 (GB) 2017289.6

(51) Int. Cl. A01D 41/127

(52) U.S. Cl. CPC A01D 41/1274; A01F 12/444; A01D 41/1276

(57) ABSTRACT

A combine harvester, and method of control involves conveying a crop material stream through a grain cleaning system which has screening apparatus. A cleaning airstream (X) is generated by a fan which is driven by a hydraulic fan drive system. The cleaning airstream (X) is directed through the screening apparatus. A fan drive pressure of a hydraulic supply line within the fan drive system is measured with a sensor. A material quantity value is calculated from the fan drive pressure. A working unit of the combine harvester is controlled using the material quantity value.

### FIELD OF THE INVENTION

The invention relates to combine harvesters having threshing apparatus, separating apparatus, a grain cleaning system located downstream of the separating apparatus, wherein the grain cleaning system comprises screening apparatus, and a fan arranged to generate a cleaning airstream through the screening apparatus. The invention also relates to a method of controlling a combine harvester having a grain cleaning system.

### BACKGROUND OF THE INVENTION

The process of harvesting grain from crop fields has not changed substantially for many decades. Farmers use combine harvesters to cut a standing crop, thresh the crop material, separate the grain from the stem and clean the grain whilst returning the crop material residue onto the field. Typically, combine harvesters include threshing apparatus, separating apparatus and a grain cleaning system.

Grain cleaning systems utilise screening apparatus which typically includes one or more sieves driven in an oscillating motion. A mixture of grain, chaff, unthreshed heads and straw is delivered to an uppermost sieve upon which the mixture is conveyed across the surface thereof. Hereinafter the chaff and straw will be referred to as ‘MOG’, Material Other than Grain.

Generally speaking, clean grain finds its way down through the sieves to a collection trough. A cleaning fan is provided to generate a cleaning airstream through the cleaning apparatus. The cleaning airstream is directed through and/or over the sieves so as to lift and carry the MOG away from the surface of the sieves and eject it from the cleaning system. The sieves are generally set up to screen the unthreshed heads which are ‘returned’ as tailings to a rethreshing system.

Today it is known to provide combines with control systems that automatically adjust settings of the various crop processing apparatus. Such “auto-setting” functionality relieves the operator of making manual adjustments to optimise the harvesting process, wherein the optimum settings continuously change as harvest conditions vary. However, for reliable auto-setting operation an accurate representation of the current conditions within the various processing apparatus is required.

### SUMMARY OF THE INVENTION

According to a first aspect of the invention there is provided a method of controlling a combine harvester comprising the steps of conveying a crop material stream through a grain cleaning system having screening apparatus, generating a cleaning airstream with a fan which is driven by a hydraulic fan drive system. The cleaning airstream is directed through the screening apparatus. A fan drive pressure of a hydraulic supply line within the fan drive system is measured. A material quantity value is calculated from the fan drive pressure. A working unit of the combine harvester is controlled using the material quantity.

According to a second aspect of the invention there is provided a combine harvester comprising threshing apparatus, separating apparatus, and, a grain cleaning system located downstream of the separating apparatus. The grain cleaning system comprises screening apparatus, a fan arranged to generate a cleaning airstream through the screening apparatus, wherein the fan is driven by a hydraulic fan drive system, and, a sensor configured to sense a fan drive pressure of a hydraulic supply line within the fan drive system. A controller is configured to control a working unit of the combine harvester based upon a material quantity value derived from the fan drive pressure.

Aspects of the invention involve the recognition that the material load upon the grain cleaning system is proportional to the power consumption of the fan drive system. For a hydraulically-driven cleaning fan the hydraulic pressure on the supply side provides at least a good estimation of the cleaning system load attributed to the MOG. By measuring the hydraulic pressure of the cleaning fan drive system, the MOG load at a given time can thus be simply determined.

In one embodiment the fan drive system, for example the fan speed, is controlled using the material quantity value. A sensed higher fan drive pressure indicates a greater load upon the fan and thus a greater volume of MOG in the grain cleaning system. If a high fan drive pressure is sensed then, in one embodiment, the controller acts to increase the speed of the cleaning fan to maintain a cleaning airstream with sufficient speed and to reduce the risk of the sieves collapsing (the scenario of crop material piling up on the sieves). If, on the other hand, a low fan drive pressure is sensed then, the controller acts to decrease the speed of the cleaning fan to reduce the risk of airborne grain being lost through the rear of the cleaning system. In one embodiment the fan speed is controlled by a closed loop control algorithm wherein a set point for the fan speed is proportional to the hydraulic fan drive pressure, with the aim of achieving a negative feedback control for the fan speed.

In another embodiment a variable opening of the screening apparatus is controlled using the material quantity value. For example, the controller may act to open the sieve or sieves in response to sensing a high fan drive pressure to reduce the risk of the sieves collapsing. Conversely, the controller may act to close the sieves in response to sensing a low fan drive pressure to maintain cleanliness of the grain sample passing through the sieves.

In another embodiment, the material quantity value is used as an input to determine a separation efficiency with respect to the separation of grain from MOG. The controller may be configured to maximise the MOG separation efficiency by adjusting and optimising at least one of a rotor speed, concave clearance or ground speed of the machine using a closed loop iterative control for example. Advantageously, the MOG load in the grain cleaning system in conjunction with the total material throughput can be correlated to the effectiveness of the threshing and separating apparatus. A higher MOG load may be used as an indicator of suboptimal separation, and, in one embodiment, the controller may perform an adjustment or optimisation of a working unit.

### BRIEF DESCRIPTION OF THE DRAWINGS

Further advantages of the invention will become apparent from reading the following description of specific embodiments with reference to the appended drawings in which:

FIG. 1 is a schematic side elevation of a combine harvester in accordance with an embodiment of the invention, shown with the side panels removed to reveal the inside processing systems;

FIG. 2 is a schematic side view of the material conveyance system and grain cleaning system in the combine harvester of FIG. 1;

FIG. 3 is a block diagram of the grain cleaning system embodied in the combine harvester of FIG. 1;

FIG. 4 is a simplified schematic of a hydraulic fan drive system embodied in the combine harvester of FIG. 1 and,

FIG. 5 illustrates a method in accordance with an embodiment.

### DETAILED DESCRIPTION OF SPECIFIC EMBODIMENTS OF THE INVENTION

Aspects of the invention will now be described in connection with various preferred embodiments implemented on a combine harvester. Relative terms such as front, rear, forward, rearward, left, right, longitudinal and transverse will be made with reference to the longitudinal vehicle axis of the combine harvester travelling in the normal direction of travel. The terms “direction of conveyance”, “upstream” and “downstream” are made with reference to the general flow of crop material through the combine harvester, or to the cleaning airstream through the screening apparatus.

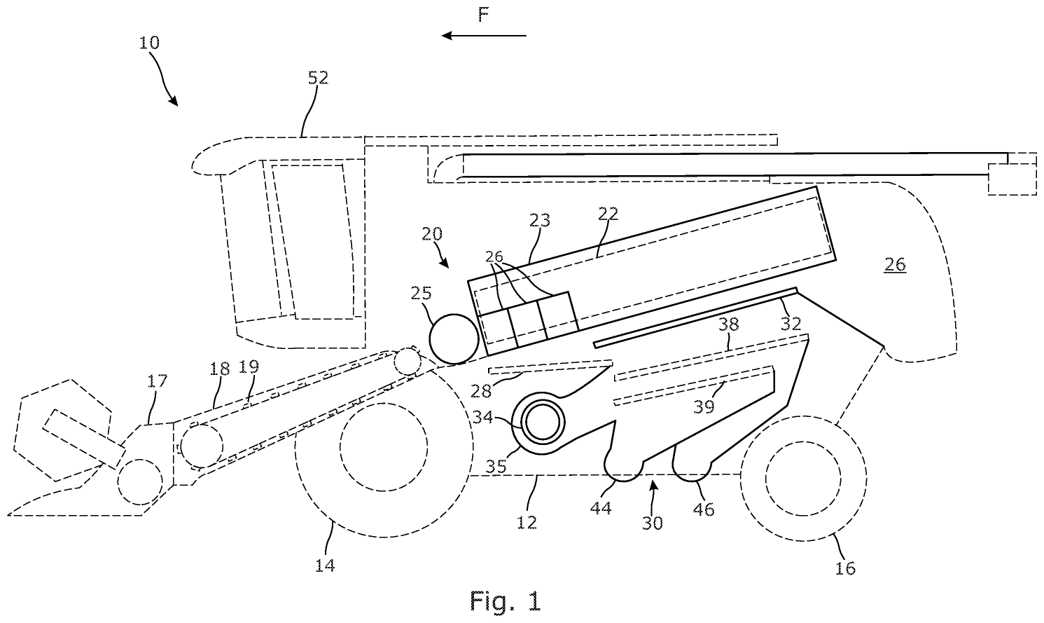

With reference to FIG. 1 a combine harvester 10 includes a frame or chassis 12, front wheels 14 and rear steerable wheels 16. A cutting header 17 is detachably supported on the front of a feederhouse 18 which is pivotable about a transverse axis to lift and lower the header 17 in a conventional manner.

The combine 10 is driven in a forward direction F across a field of standing crop in a known manner. The header 17 serves to cut and gather the crop material before conveying such into feederhouse 18 and elevator 19 housed therein. At this stage the crop stream is unprocessed. It should be understood that combine harvesters are employed to harvest a host of different crops including cereal, rice, beans, corn and grass seed. The following description will make reference to various parts of the cereal crop stream but it should be understood that this is by way of example only and does not by any means limit the applicability of the invention to harvester other crops.

The cut crop stream is conveyed rearwardly from the feederhouse 18 to a processor designated generally at 20. In the illustrated embodiment the processor 20 is of the axial rotary type having a pair of axial-flow threshing and separating rotors 22 which are each housed side-by-side inside a respective rotor housing 23 and are fed at their front end by a feed beater 25. It should be appreciated that the right-hand rotor is hidden from view in FIG. 1. The rotors serve to thresh the crop stream in a front ‘threshing’ region, separate the grain therefrom in a rear ‘separating’ region, and eject the straw residue through the rear of the machine 26 either directly onto the ground in a windrow or via a straw chopper (not shown).

Each rotor housing 23 is generally cylindrical and is made up of an opaque upper section and a foraminous lower section which includes a set of side-by-side arcuate concave grate segments 26 extending the length of the front threshing region and which allow the threshed material to fall by gravity onto a shoe preparation pan 28 located below for onward conveyance to a grain cleaning system which is designated generally at 30. Guide vanes (not shown) are secured to the inside of the rotor housing and serve, in conjunction with the crop engaging elements on the rotor 22, to convey the stream of crop material in a generally rearward spiral path from front to rear.

The separating region at the rear portion of rotors 22 comprises plural crop engaging elements (not shown) to separate the residual grain from the stream of crop material. A grain return pan 32 is provided underneath the separating region to collect the separated grain and convey it forwardly for delivery onto the grain collection pan 28. Both the shoe preparation pan 28 and return pan 32 are driven with a drive mechanism so as to oscillate in a known manner.

Although described as a rotary axial type, the processor 20 may be of an alternative type such as known conventional, hybrid or transverse types without departing from the scope of the invention. For example, in the case of a conventional type processor, a transverse cylindrical beater may be provided as threshing apparatus and a set of straw-walkers provided as separating apparatus.

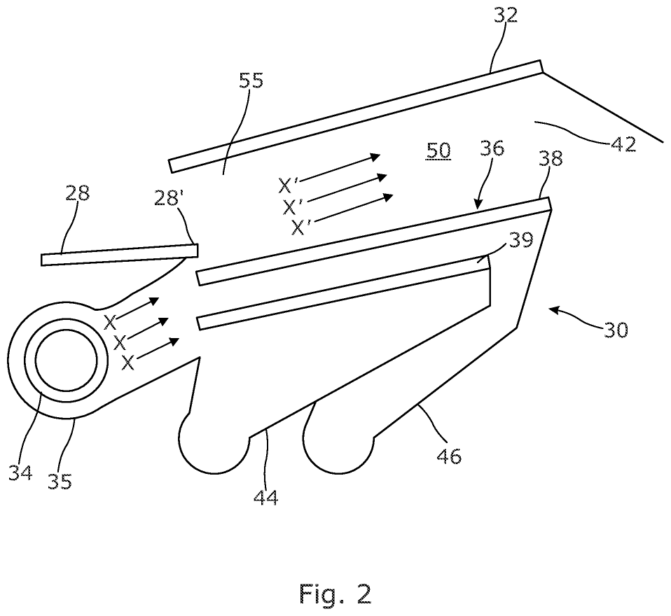

With reference to FIGS. 1 and 2 the grain cleaning system 30 comprises a fan 34 housed in a fan housing 35. The fan 34 may be of a known type such as a crossflow or centrifugal fan that rotates on a transverse axis and draws in air either tangentially or axially through air intake openings. A cleaning airstream generated by the fan 34 and exhausted from the fan housing 35 is represented in FIG. 2 by arrows ‘X’.

The fan 34 is driven by a hydraulic fan drive system 400 which is shown in more detail in FIG. 4. The fan drive system 400 is operable to drive the fan 34 with an adjustable speed determined by an electronic fan controller 134. The fan 34 derives its torque from a hydraulic motor 402 which is driven by a hydraulic pump 404. The speed of the fan 34 is controlled by a control valve 406 which is controlled by the fan controller 134. It should be understood that the very simple hydraulic circuit shown in FIG. 4 is to illustrate aspects of the invention only, and that the circuit may include more components. In one embodiment the pump 404 supplies pressurised fluid to more hydraulic consumers on the combine 10.

A fan drive pressure sensor 408 is connected in hydraulic communication with the high pressure side of the motor 402. The pressure sensor 408 is configured to sense the pressure of the hydraulic fluid on the high pressure side of the motor 402 and generate an electrical signal therefrom for communicating to an electronic control unit 101.

Turning back to FIG. 2, the grain cleaning system 30 further comprises screening apparatus 36 which includes a shoe frame (not shown), upper sieve 38 (alternatively referenced ‘chaffer’) and a lower sieve 39. The sieves 38, 39 are driven with an oscillating motion in a known manner. The sieves 38, 39 are mounted between side members of the shoe frame which is suspended on hangers (also not shown) from the frame 12 and driven in an oscillating motion.

It should be understood that the return pan 32 may be shorter than shown wherein crop material falls from the front edge direct into the grain cleaning system 30. In alternative embodiments the preparation pan 28 may be omitted altogether.

The sieves 38, 39 each comprise a plurality of transverse louvres which can be adjusted either manually or remotely to adjust the coarseness of the screen provided. The louvres are arranged in a parallel transverse relationship and pivot to adjust the opening or gap between adjacent ones.

The threshed material, comprising a mixture of grain and MOG, is conveyed by the shoe preparation pan 28 in a rearward direction until it falls from a rear edge 28′ and into the grain cleaning system 30. The cleaning airstream is directed through and over the sieves 38, 39 in a known manner so as to lift the lighter material, primarily MOG, away from the surface of upper sieve 38 and in a rearward direction for ejection at a rear outlet 42.

In a known manner, the screening apparatus 36 is operable to allow the clean grain to pass through the sieves 38, 39, wherein the clean grain is collected in a transverse clean grain trough 44 and conveyed onwards to an on-board grain tank (not shown). The louvres of upper sieve 38 may be set to allow unthreshed heads to pass through a rear region of the upper sieve 38 into a tailings collection trough 46. Likewise, any material screened out by lower sieve 39 falls from the rear edge thereof into the tailings collection trough 46 from where the ‘returns’ are fed back to the processor 20 or a dedicated rethreshing system (not shown).

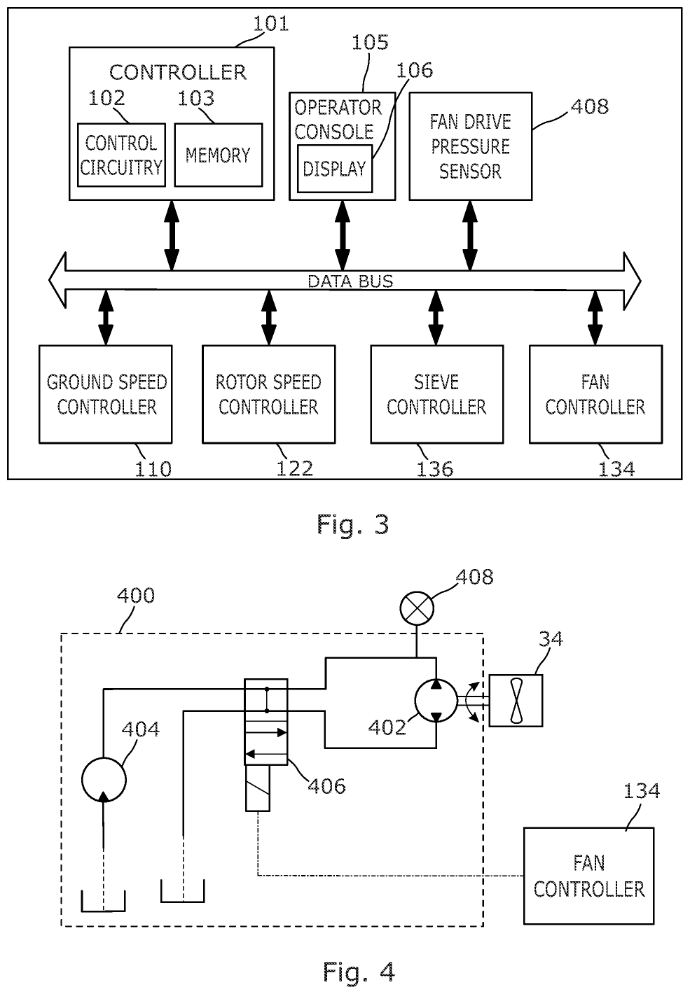

With reference to FIG. 3, the electronic control unit (hereinafter termed ‘ECU’) 101 is in communication (via a data bus) with an operator console 105, a ground speed controller 110, a rotor speed controller 122, a sieve controller 136, and the fan controller 134. The ECU 101 comprise control circuitry 102 which may be embodied as custom made or commercially available processor, a central processing unit or an auxiliary processor among several processors, a semi-conductor based micro-processor (in the form of a micro-chip), a macro processor, one or more applications specific integrated circuits, a plurality of suitably configured digital logic gates, and/or other well-known electrical configurations comprising discrete elements both individually and in various combinations to coordinate the overall operation of the combine 10.

The ECU 101 further comprises memory 103. The memory 103 may include any one of a combination of volatile memory elements and non-volatile memory elements. The memory 103 may store a native operating system, one or more native applications, emulation systems, emulated applications for any of a variety of operating systems and/or emulated hardware platforms, emulated operating systems etc. The memory 103 may be separate from the controller 101 or may be omitted.

The operator console 105 comprises a display 106 which may be integrated as part of a terminal having user interface devices such as buttons, levers and switches. The console 105 is mounted proximate to a drivers work station in cab 52.

The ground speed controller 110, rotor speed controller 122, sieve controller 136, and fan controller 134 each serve to control adjustments of respective working units of the combine 10 and may each comprise a local standalone processor and/or memory, or may be integrated into the central ECU 101. Control signals generated by the ECU 101 are communicated to the respective working unit controllers 110, 122,136,134 which are then translated into an adjustment of the associated working unit including the processing rotor 22, sieves 38, 39 and fan 34.

In one embodiment, the ECU 101 is configured to calculate a material quantity value or parameter which is indicative of, or proportional to, the MOG load present at a given time in the cleaning system 30. The material quantity value (hereinafter referenced as ‘MOG load value’) is derived from the fan drive pressure which is sensed by sensor 408. The MOG load value is utilised in one embodiment by the ECU 101 as a variable input parameter for the direct control of the speed of fan 34. For example, if the MOG load value is found to increase over a predetermined time period then the speed of the fan 34 is increased proportionately (by adjustment of valve 406) to maintain an effective velocity of the cleaning airstream X.

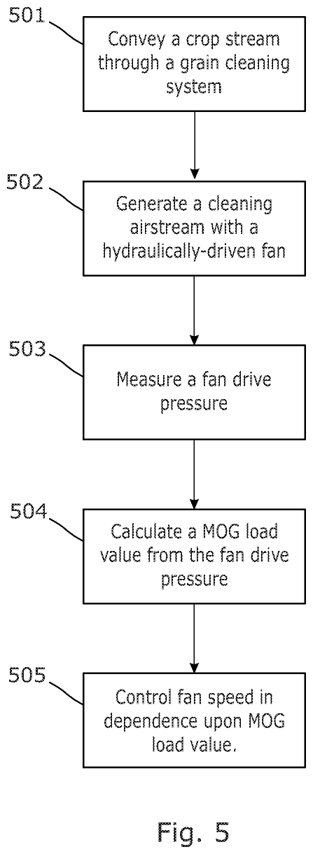

With reference to FIG. 5, a method in accordance with an embodiment is illustrated in a process flow in which a crop stream is conveyed through a grain cleaning system at step 501. For example, a mixture of grain and MOG may be conveyed generally rearwardly through cleaning system 30. At step 502 a cleaning airstream is generated with a hydraulically-driven fan such as by fan 34 described above. The cleaning airstream is preferably directed through screening apparatus.

At step 503 the hydraulic pressure on the high pressure side of the fan drive system 400 is measured with a sensor, such as pressure sensor 408. A MOG load value is then calculated at step 504 from the fan drive pressure measured at step 503. At step 505 the speed of fan 34 is controlled in dependence upon the MOG load value calculated at step 504.

From reading the present disclosure, other modification will be apparent to persons skilled in the art. Such modifications may involve other features which are already known in the field of grain cleaning systems, component parts, and automatic setting systems therefore, and which may be used instead of or in addition to features already described herein.

1. A method of controlling a combine harvester comprising the steps of:
conveying a crop material stream through a grain cleaning system having screening apparatus;
generating a cleaning airstream with a fan which is driven by a hydraulic fan drive system, wherein the cleaning airstream is directed through the screening apparatus;
measuring a fan drive pressure of a hydraulic supply line within the fan drive system;
calculating a material quantity value from the fan drive pressure; and,
controlling a working unit of the combine harvester using the material quantity value.

2. A method according to claim 1, wherein the fan drive system is controlled using the material quantity value.

3. A method according to claim 1, wherein a variable opening of the screening apparatus is controlled using the material quantity value.

4. A method according to claim 1, the material quantity value is used as an input parameter to determine a separation efficiency with respect to the separation of grain from MOG.

5. A method according to claim 4, wherein the separation efficiency is maximised by adjusting and optimising at least one of a rotor speed, concave clearance or ground speed of the machine using a closed loop iterative control process.

6. A combine harvester comprising:
threshing apparatus,
separating apparatus, and,
a grain cleaning system located downstream of the separating apparatus,
wherein the grain cleaning system comprises:
screening apparatus;
a fan arranged to generate a cleaning airstream through the screening apparatus, wherein the fan is driven by a hydraulic fan drive system; and,
a sensor configured to sense a fan drive pressure of a hydraulic supply line within the fan drive system;
wherein a controller is configured to control a working unit of the combine harvester based upon a material quantity value derived from the fan drive pressure.

7. A combine harvester according to claim 6, wherein the controller is configured to control the fan drive system based upon the material quantity value.

8. A combine harvester according to claim 6, wherein a variable opening of the screening apparatus is controlled using the material quantity value.
